(19) United States
(12) Patent Application Publication
(10) Pub. No.: US 2022/0412485 A1
(43) Pub. Date: Dec. 29, 2022

(54) WELDLESS BULKHEAD SEAL

(71) Applicant: Jeremy Elijah-Raign Reidy, Williamsport, PA (US)

(72) Inventor: Jeremy Elijah-Raign Reidy, Williamsport, PA (US)

(73) Assignee: Hobby Beverage Equipment Co., LLC, Williamsport, PA (US)

(21) Appl. No.: 17/359,576

(22) Filed: Jun. 27, 2021

(51) Int. Cl. F16L 5/06

(52) U.S. Cl. CPC F16L 5/06; F16L 19/0286

(57) ABSTRACT

The present invention relates to a stainless steel weld-less bulkhead seal device that facilitates the transportation of liquid from one containment system to another container or to allow such liquid to be retrieved from the original containment without the need for welding parts and fittings on the exterior of the container. The head of the bulkhead comprises six sides for easy installation, a shaft at the front of the bulkhead, a pair of ribbed buna gaskets for effective leak proof sealing, and a set of internal threads on the shaft of the bulkhead, which allows for additional pieces of threaded hardware to be attached to the bulkhead. A locking nut is threaded onto the outside of the bulkhead shaft, whereby these threads are tightened by turning to the left. That is to say they are reversed threads which will better resist pressure from the inside of the containment system or tank.

### CROSS-REFERENCE TO RELATED APPLICATION

This application claims the benefit of U.S. Provisional Patent Application No. 63/160,857, filed Mar. 14, 2021, which is incorporated by reference herein in its entirety.

### FIELD OF INVENTION

The present invention relates to a fitting device, particularly a stainless steel weld-less bulkhead sealing device that allows the user to transport liquid from one liquid containment system/tank to another container or to allow such liquid to be retrieved from the original containment system/tank without the need of welding parts and fittings on the exterior of the container.

### BACKGROUND OF INVENTION

Bulkheads are fittings often used on fluid containment systems, tanks, kettles, brew tanks, fermenting tanks, and other form of containment or containers. They are separate fittings or devices attached to a container to resist pressure or to shut off water or gas. They are also used in transporting liquid from one containment system into another container or to be retrieved from the original containment system without the need for welding parts and fittings on the exterior of the containment system.

### DESCRIPTION OF RELATED ART

U.S. Pat. No. 7,581,976B2 discloses a bulkhead connector assembly providing a sealing arrangement for seemingly feeding a conduit between two environments. The assembly provides a first and second coupling components having a first and second surface respectively. A gap is formed between the first and second surfaces. The first coupling component has an aperture which extends between the first surface and a first environment and the second coupling component has an aperture which extends between the second surface and a second environment. The present invention presents us with a complex operation and so it's installation is cumbersome and not easy to use.

US20170248257A1 relates to fittings and, more particularly to a fitting having an integrated dip tube. A weld less through wall fitting that provides a leak free connection to a vessel that can easily be installed and removed. The fitting also provides an integrated, removable, and repositionable dip tube to allow the liquid stored in the vessel to be drained via gravity to a level below the entry point of the fitting.

U.S. Ser. No. 10/663,096B2 discloses a bulkhead fitting and a method for electrically separating two fluid lines across a structural boundary. Fluid is transported between a first channel through a first fluid line and a second channel through a second fluid line across the structural boundary formed by a structure. The first channel and the second channel are connected by a channel formed by a fitting. The fitting is comprised of a first component, a second component, and an isolator.

U.S. Pat. No. 7,597,361B2 discloses a bulkhead fitting for an irrigation pipe which may be used on either six inch or eight inch diameter irrigation pipes through the use of an interchangeable base ring. The fitting includes a stem fitting having an interchangeable base ring mounted thereon which is extended upwardly through an outlet opening in an irrigation pipe.

US20040265091A1 discloses Universal bulkhead fitting comprising a flanged cylinder assembly includes a cylindrical housing having an axis and defining a bore along the axis. A spirally threaded groove is defined within the bore. The groove is spirally situated about the bore. The groove is arranged to engage a threaded land on a shaft of a fastener to secure the fastener in the bore.

U.S. Pat. No. 5,439,256A discloses a bulkhead fitting for draining fluids off the topside of a thin flexible barrier cover, comprising: a male threaded member, a female threaded member, and an o-ring seal.

KR100736254B1 discloses a non-welding water storage structure having a tensioned top plate structure, which is a fluid storage means used for applications such as a drainage basin, agglomeration basin, an intermittent tap water, a tank type water purification plant, etc. It relates to a weld-free storage structure having a tension top plate structure applied to the storage tank.

KR200328383Y1 discloses a water tank having multi-bulkheads that can be sanitarily purified and can be easily installed by equipping the general water treatment plant with multiple partition structures

The problem with conventional bulkhead connectors is that often, the fittings have to be welded on to the outside of a tank to allow fluid to be retrieved through a valve. Also, stainless steel conventional bulkhead connectors cannot be welded on to plastic containment systems such as HPDE plastic tanks or fermenters. It is therefore desirable to have a bulkhead connector/seal that provides an effective solution to the aforementioned problems, as well as provide the ability to attach fittings, such as filtration devices on the inside of the tank as well.

The present invention aims to solve the above mentioned problems by providing a system that eliminates the welding of steel bulkhead fittings to containment systems or tanks to allow the retrieval or shutting off of fluid inside such containment systems. The present invention also facilitates the use of stainless bulkhead fittings with HDPE or plastic fluid containers or tanks, which can then allow for additional food grade stainless steel hardware to be attached to said container (inside and outside said container) allowing fluids to be retrieved and/or filtered with attachments.

### SUMMARY OF THE INVENTION

The following summary discloses all the features and functions of the present invention. By considering the whole specification, claims, drawings and abstract, one can easily get a full understanding of the invention and how it functions.

The present invention consists of a stainless steel weld-less bulkhead having six side edges on the head of the bolt end, for easier installation and removal. The invention further comprises one set of threads located on the interior portion of the shaft that are exactly half of the length of the entire shaft of the bulkhead. This allows for additional pieces of threaded hardware to be attached to the bulkhead, both inside the tank and outside of the tank, thereby, facilitating the transfer of liquid from inside of a liquid tank/containment system to the outside using varieties of attachments such as a ball valve & filters. The invention further discloses two Food Grade Nitrile Rubber, (Buna-N gaskets) wherein the said gaskets further comprise two raised ribs to allow for four additional layers of sealing that would go beyond traditional Teflon Tape used on threads of any pipe material when dealing with fluids. The ribs on the front side of each gasket allow them press against the tank walls to ensure maximum ability to provide a leak proof seal. The second gasket is fitted on to the shaft of the bulkhead, on the outside of the tank. Together, the gaskets provide easy sealing capability on both the inside of the tank and the outside of the tank when properly fitted. The invention further discloses a locking nut which comprises of a plurality of reversed circular NPT threads which are designed to be tightened by threading to the left side.

### BRIEF DESCRIPTION OF DRAWINGS

FIG. 1 discloses a frontal perspective view of the front of the weld-less bulkhead with the gaskets attached;

FIG. 2 discloses a rear perspective view of the back side of the bulkhead;

FIG. 3 discloses a perspective view of the two Food Grade Nitrile Rubber (Buna-N) gaskets;

FIG. 4 discloses a perspective view of the bulkhead showing the internal threads, and attached are the locking nut and the gaskets;

FIG. 5 discloses a perspective view of the locking nut of the bulkhead;

FIG. 6 discloses a side view of the whole invention in an arranged position.

### DETAILED DESCRIPTIONS OF DRAWINGS

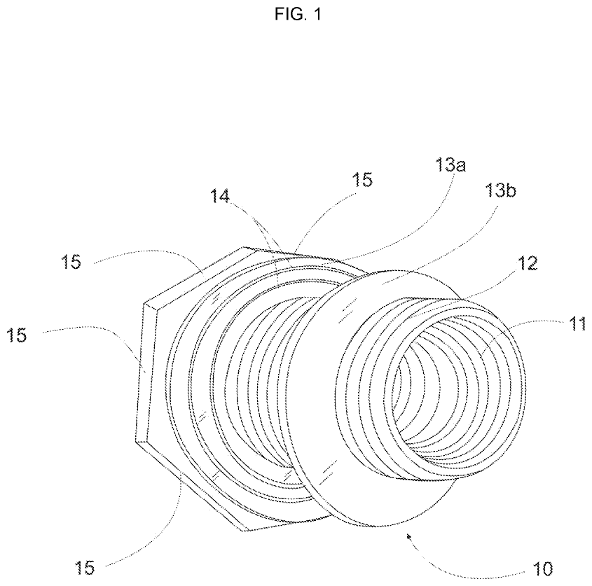

In FIG. 1, the present invention comprises the front side of the head of the stainless steel weld-less bulkhead further comprising six sides on the head of the bolt end (15) to allow for easier installation and removal. The front of the bulkhead consists of a shaft (12) which allows the first and second food grade Buna-N gaskets (13a, 13b) to be seated (on the inside and outside of the tank respectively) with the ribs (14) of the gaskets against the tank wall (21). The Buna-N gaskets (13a, 13b) further consist of two sets of ribs (14) on the front side to allow them press against the interior of the tank wall (and on the exterior by the second gasket) to ensure maximum ability to provide a leak-proof seal. The second Buna-N gasket (13b) fits on the same shaft 12, on the outside of the tank. Thereby allowing the two sets of raised ribs (14) to also ensure maximum sealing capability on the outside of the tank. The invention also comprises two set of internal threads (11) on the shaft (12) of the bulkhead, which allows for additional pieces of threaded hardware to be attached to the bulkhead allowing liquid to be transferred from inside of the tank to the outside using various attachments, such as a ball valve.

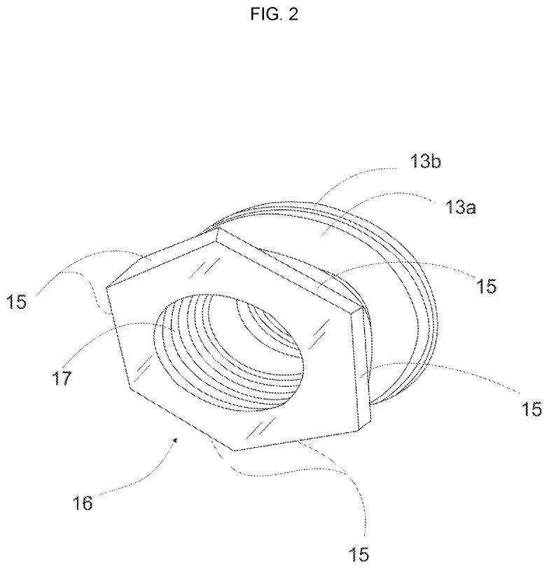

In FIG. 2, the present invention discloses the back side of the head of bulkhead (16) consisting of six sides (15), the two Buna-N gaskets (13a, 13b), the first gasket (13a) seats against the head of the bulkhead, and the second set of internal threads (17) on the inside of the shaft of the bulkhead. This set of threads (17) is exactly the same as the threads accessed from the outside of the tank, and these threads allow for attachment of various screening devices to allow for filtration of the liquid that is being retrieved from inside the tank to outside the tank or to another containment system.

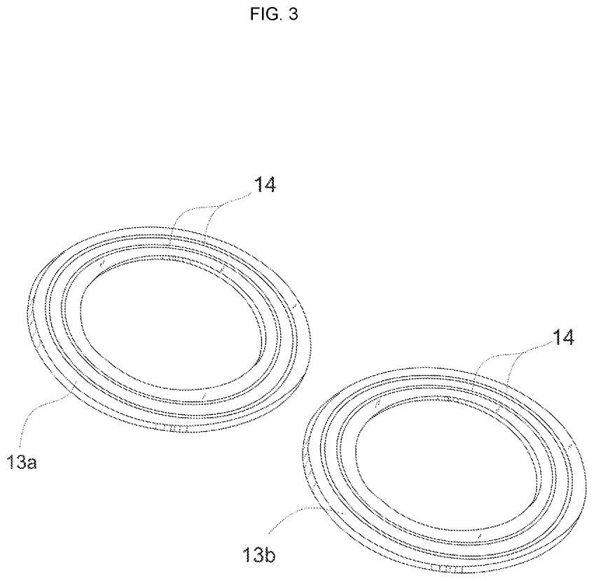

in FIG. 3, the invention discloses the front side of the food grade Buna-N gaskets (13a, 13b). There are two Buna-N gaskets utilized on the weld-less bulkhead seal and the first of the gaskets (13a) is placed on the shaft of the weldless bulkhead on the inside of the tank, while the second gasket is placed on the shaft of the weldless bulkhead on the outside of the tank. The gaskets comprise two sets of raised ribs (14) on the gaskets to allow four additional layers of sealing on the walls of the tank. Gasket material may vary based on use & demand. EPDM is another viable gasket material.

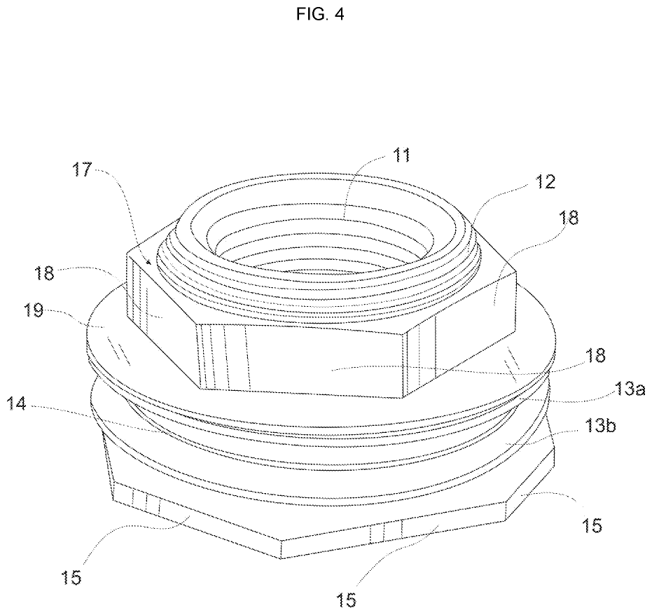

In FIG. 4, the invention discloses the locking nut (17), the sides (18) of the locking nut, the internal threads of the bulkhead's shaft (11) which are the same set of internal threads illustrated in part (11) of the bulkhead disclosed in FIG. 1. These threads are NPT threads and are designed to allow attachments to be made on the outside of the tank to allow liquid to flow. The locking nut is threaded onto the shaft (12) of the weld-less bulkhead seal. Furthermore, the locking nut is designed to tighten to the left side by threading to the left side. The left handed threads are used in specialized applications in which the application of pressure would force a right handed screw or bolt to come loose. FIG. 4 also discloses the sides of the head of the bulkhead (15).

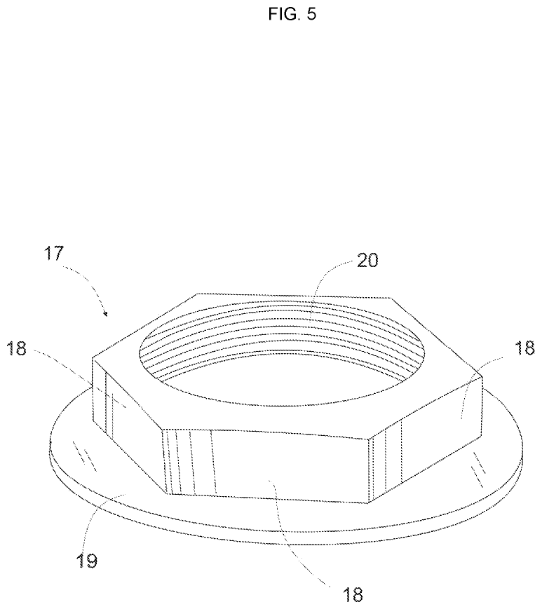

in FIG. 5, the invention discloses the sides of the locking nut (18), the interior view of the internal threads (20) on the locking nut, these threads are reversed. Also disclosed is the flat side of the locking nut (19) under which the second Buna-N gasket (13b) in FIG. 1. would be placed on the shaft (12) (as seen in FIGS. 1 and 4) of the weldless bulkhead seal to provide additional sealing capability to bulkhead.

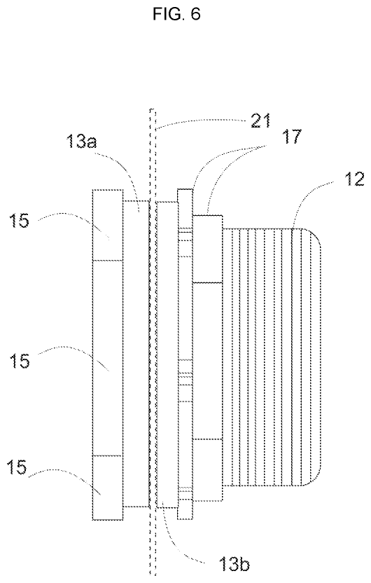

In FIG. 6, the whole invention is shown in an arranged position and it comprises the shaft of the bulkhead (12), the locking nut (17), the two Buna-N gaskets (13a, 13b), the sides of the bulkhead (15) and the tank wall (21) in broken lines.

### How the Invention is Used

The most widely used application of the Weldless Seal Bulkhead is as a weldless bulkhead fitting installed on the inside of a tank or containment device through a hole which has been cut out of the tank. This will allow for liquids to be retrieved from the tank or container without the need for welding hardware on the outside of the tank.

The invention of the Weldless Bulkhead Seal also allows for Food Grade Stainless Steel to be installed on tanks made of HDPE Plastic (or like materials) which would not be able to be welded into with metal accessories, like a metal ball valve.

The Shaft of the Weldless Bulkhead Seal is placed through the hole with a gasket installed on the portion of the shaft that is now inside the tank wall. On the outside of the tank, shaft of the bulkhead has another Buna-N gasket installed to provide additional layers of sealing on the outside of the tank. The locking nut is reversed to be able to better withstand the pressure on the inside of the tank.

The set of threads on the internal portion of the bulkhead allow for various attachments to be made to the Weldless Seal Bulkhead fitting. These threads are NPT sized which allow for a wide array of attachments to be made, and allow for customization of use.

Most common attachments are made to the set of threads accessed on the aspect of the bulkhead which are outside of the tank or containment system will allow for fluid retrieval, such as a ball valve.

The set of threads which would be accessed from inside of the tank or containment system allows for various threaded screening devices or threaded filtration systems to be installed inside the tank thereby filtering liquids before they are retrieved.

Another way of using the invention is to use the set of Internal threads on the shaft of the bulkhead to install a water heating element to a tank or containment system. Whereby the heating element controls are accessed from outside the tank, thus allowing water in said container to be heated using the heating element.

1. A stainless steel weld-less bulkhead seal comprising of six sides/edges on the head of the bolt end (12) in FIG. 1. for easy installation/removal and a shaft (13) FIG. 1.

2. A stainless steel weld-less bulkhead seal according to claim 1 whereby the said bulkhead further comprises two sets of threads on the interior aspect of the shaft (11) as seen in FIG. 1. and that are exactly half of the length of the entire shaft (13) of the bulkhead;

3. A stainless steel weld-less bulkhead seal according to claim 2 whereby the internal set of threads allows for additional pieces of threaded hardware to be attached to the bulkhead when installed, also allows liquid to be transferred from inside the tank to outside the tank, using various attachments such as ball valve and allows for a threaded filtration device to be threaded on the inside of the tank, which filters fluids before retrieval.

4. A stainless steel weld-less bulkhead seal according to claim 1 whereby the said bulkhead further comprises twin Buna-N gaskets (10) wherein the said gaskets are made of food grade nitrile rubber, (Buna-N). Gasket Material can vary from EPDM to Food Grade Nitrile Rubber, Based on Use & Demand.

5. A stainless steel weld-less bulkhead seal according to claim 4 whereby the Buna-N gaskets further consists of two sets of raised ribs (16) on the front side to allow them press against the tank walls to ensure a leak proof seal;

6. A stainless steel weld-less bulkhead seal according to claim 1 whereby the said bulkhead further comprises a locking nut which further comprises of a set of reversed NPT threads on the outside of the shaft of the bolt which allows for specialized applications in which the application of pressure would force a right handed screw or bolt to come loose.

7. A stainless steel weld-less bulkhead seal according to claim 6 whereby the said the locking nut is designed to tighten to the left side by the reversed NPT threading.
